(19) United States
(12) Patent Application Publication
(10) Pub. No.: US 2003/0135732 A1
(43) Pub. Date: Jul. 17, 2003

(54) Method for using a service, a system, and a terminal

(75) Inventor: Antti Vaha-Sipila, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/328,858

(22) Filed: Dec. 24, 2002

(30) Foreign Application Priority Data
Dec. 27, 2001 (FI) 20012579

(51) Int. Cl. H04L 9/00

(52) U.S. Cl. 713/156

(57) ABSTRACT

The invention relates to a method for using a service (7) at a terminal (6). In the method, for using a service (7), at least one certificate is transmitted (303, 406) from the terminal (6) to said service (7). In the service (7), requirements are set for the data content of the certificate. Information about said requirements is transmitted (301) from the service (7) to the terminal (6), in which a certificate acquisition step (402, 403, 404) is taken to acquire a certificate complying with the requirements, and a certificate transmission step (303, 406) is taken to transmit the acquired certificate to said service (7). The invention also relates to a system (1), in which the method is applied, as well as to a terminal (6) to be used in the system (1).

### CROSS-REFERENCE TO RELATED APPLICATIONS

This application claims priority under 35 USC §119 to Finnish Patent Application No. 20012579 filed on Dec. 27, 2001.

### FIELD OF THE INVENTION

The present invention relates to a method for using a service at a terminal, in which method for using the service, at least one certificate is transmitted from the terminal to said service, and requirements for the data content of the certificate are set in the service. The invention also relates to a system comprising services, means for using at least one service at a terminal, means for transmitting at least one certificate from the terminal to said service for using the service, and in which service, requirements are set for the data content of the certificate. Further, the invention relates to a terminal to be used in a system comprising services, which terminal comprises means for using at least one service at a terminal, means for transmitting at least one certificate from the terminal to said service for using the service, and in which service, requirements are set for the data content of the certificate.

### BACKGROUND OF THE INVENTION

In connection with some services, certificates are not necessarily applied to enable the use of the service, but the user must register him/herself in the service before using it. In connection with the registration, the user must normally enter some compulsory information, and in addition to that, the user may voluntarily enter other information about him/herself. If the user has filled in all the compulsory data, the right is granted to use the service. In this context, the user is given data, on the basis of which the user can use the service also later on. This data includes, for example, a user identification and a password. Thus, the user will be identified on the basis of the user identification and the password. The information which must be entered at the stage of registration depends e.g. on the service provider and the service. In some cases, it is sufficient to enter an e-mail address, but in some services, it may be necessary to enter name, age, sex, address and even hobbies, before the registration is accepted.

Information about the user can be collected by several different service providers. Also, the authorities may have electronic databases containing stored information about users. By combining information stored in different locations, it is, in theory, possible to obtain a relatively extensive conception of the person in question, such as hobbies, age, sex, place of residence, bankers, etc. The privacy of the person may be at risk, if a third party can collect data stored by different service providers about the users of their services. This collected information can be used, for example, for advertising purposes or for surveillance of the user without the user knowing it.

All service providers do not necessarily need to collect detailed data about the user, if user verification can be implemented by other means in a sufficiently reliable way. One way to implement this is to use so-called certificates. Certificates are used in many communication systems to verify the identity of the user and to grant rights to use a service formed in the system, such as a banking service, a trading service, etc. By means of certificates, the user can prove his/her identity to the service provider. Thus, for example in banking services, the user may show that he/she is authorized, for example, to pay bills from his/her account and to scan his/her account data. In a corresponding manner, in trading services, the vendor can make sure that the customer is the correct person and that the contact data entered by him/her can be relied on. Certificates intended for such use contain information which is sufficient for the service provider to identify the user. On the other hand, in some services it is not the identity of the user that is significant for the service provider, but the factor to restrict the use may be other information, such as the user's age. Furthermore, the purpose of the certificate may primarily be to secure that the person in question is the same person as during the previous use of the service, but the identity of the person is not significant as such.

Certificates can be divided in different groups on the basis of the type of information contained in them. Identity certificates contain information, such as a name, on the basis of which the user can be identified. In a corresponding manner, pseudonymous certificates do not contain information which will directly indicate who the person is.

Certificates are granted by certain authorized communities which are in this application called certificate authorities (CA). Thus, the user contacts such a certificate authority by his/her terminal for example via the Internet data network and transmits some information about him/herself to the certificate authority. The information to be entered depends e.g. on the certificate authority. After this, the certificate authority transmits to the user's terminal an individual certificate, which is stored in the terminal. After this, the user can use this certificate in such services which accept certificates issued by said certificate authority and which contain sufficient information about the user for the service in question. The certificate authority may possibly store user-specific information when granting the certificate, wherein it may be possible to trace the user also on the basis of a pseudonymous certificate, particularly if a third party has access to the database of the certificate provider. In some countries, the storage of personal data related to certificates may be stipulated by authorities, e.g. to make it possible to supervise citizens. Also, the service provider may store user-specific information in its own system.

The user of services connected to data networks may have several different certificates for the use of different services. Thus, when registering in a service, the user must select a certificate suitable for the service in question. Thus, the user should remember where the certificates are stored in the terminal and also which certificate relates to which service.

A system has been developed in the Internet data network, whereby information can be transmitted to a terminal connected with the Internet data network about the policies of service providers relating to information to be collected from users. This system is known with the abbreviation P3P (Platform for Privacy Preferences Project). The basis for the use of the system is that the page settings for the service of the service provider are provided with settings containing information about the policy of the service provider relating to data to be collected from the user. For example, the settings may indicate that the service provider will transmit information about the user's e-mail address to other servers of the same operating range, or that the service provider may give the telephone number to a third party, or that the service provider will use data collected by it only at the registration for the service but will not give any data to third parties. The user can make certain settings relating to the policy of the service provider for example in the browser program of the terminal. For example, the user can define that if the policy of a service provider is to give any data or any specific data, e.g. the e-mail address, to third parties, the browser program will give a notice about this to the user. Thus, the user may not accept the service but can stop the registration for the service. The P3P settings are preferably added in the http protocol of the session layer, wherein the browser program must support these settings to use the P3P functions.

### SUMMARY OF THE INVENTION

It is an aim of the present invention to provide a method and a system in which the acquisition and use of certificates is as automatic as possible. The invention is based on the idea that information is transmitted from the service to the terminal about the kinds of certificates accepted by it and what other possible conditions are set for the use of the service. The certificate is provided with an identification, wherein on the basis of this identification, the certificate can also later be connected to the service in question. To put it more precisely, the method according to the present invention is primarily characterized in that information about said requirements is transmitted from the service to the terminal, which takes the step of acquiring a certificate, to acquire a certificate complying with the requirements, and the step of transmitting the certificate, to transmit the acquired certificate to said service. The system according to the invention is primarily characterized in that the system also comprises means for transmitting information about said requirements from the service to the terminal, which terminal comprises means for acquiring a certificate complying with the requirements, and means for transmitting an acquired certificate to said service. Furthermore, the terminal according to the invention is primarily characterized in that the terminal also comprises means for receiving information about said requirements, means for acquiring a certificate complying with the requirements, and means for transmitting an acquired certificate to said service.

The present invention shows remarkable advantages over solutions of prior art. The selection of the certificate is as automatic as possible, wherein the user does not need to select a suitable certificate when starting to use the service. Furthermore, in the method, the aim is to minimize the quantity of data required for acquiring and using the certificate, to avoid unnecessary transmission of data which would possibly violate the privacy protection. Also, the fact that the user does not need to transmit information about his/her certificates to the service, but the service transmits the acceptable certificate types accepted by it to the user's terminal, increases the user's privacy protection. Thus, no information about the identity of the user is obtained in the service on the basis of the types of certificates which the user has.

### DESCRIPTION OF THE DRAWINGS

In the following, the invention will be described in more detail with reference to the appended drawings, in which

FIG. 1 shows a system according to a preferred embodiment of the invention in a reduced chart,

FIG. 2 shows, in a reduced block chart, a terminal for use in the system according to a preferred embodiment of the invention,

FIG. 3 shows, in a reduced signalling chart, the selection of certificates in a method according to a preferred embodiment of the invention, and

FIG. 4 shows, in a reduced signalling chart, the acquisition of certificates in the method according to a preferred embodiment of the invention.

### DETAILED DESCRIPTION OF THE INVENTION

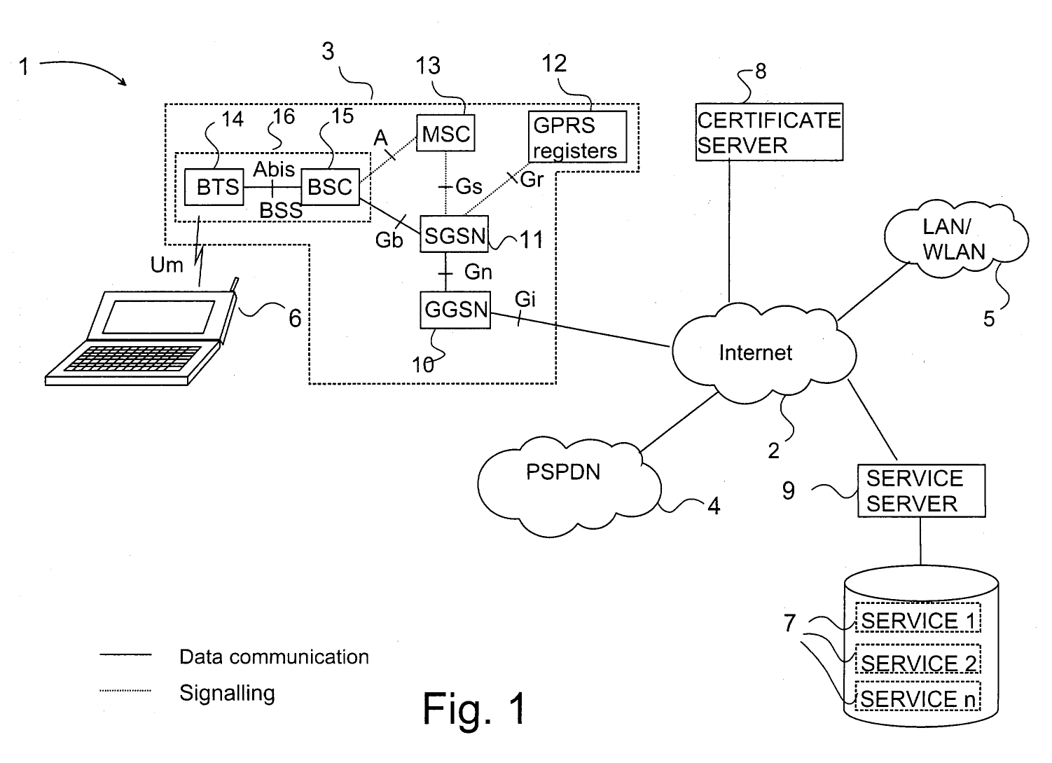

In the following, more detailed description of the invention, the system 1 of FIG. 1 will be used as an example. In the system, the user can contact services arranged in a data network 2, for example, by means of a mobile communication network 3. However, it is obvious that the invention can also be applied in systems, in which the connection is made for example via a public switched telephone network 4 or a local area network 5. In this example, the user's terminal is a portable terminal 6 which comprises data processing functions and mobile communication functions. The data network 2 is provided with services 7 offered by service providers, such as banking services, database services, shopping services, conversational services, correspondence services, etc. Each service is, in a way known as such, arranged in a server 9 communicating with the data network 2, wherein the user can set up a connection to this server 9 to use the service.

In the advantageous example of FIG. 1, the mobile communication network 3 is the packet transmission system GPRS of the GSM mobile communication system, but the invention can also be applied in other mobile communication systems, such as UMTS mobile communication networks. The main element in the infrastructure of the GSM mobile communication system for GPRS services is a GPRS support node 10, 11, a so-called GSN. It is a mobility router which implements the switching and cooperation between different data networks, for example to the public switched packet data network (PSPDN) 2 through a connection Gi, mobility management with GPRS registers 12 through a connection Gr, and transmission of data packets to portable terminals, irrespective of their location. Physically the GPRS support node 10, 11 can be integrated in a mobile switching center (MSC) 13, or it can constitute a separate network element based on the architecture of data network routers. User data travels directly between the support node 10, 11 and a base station subsystem (BSS) 16 composed of base stations (BTS) 14 and base station controllers (BSC) 15 through a connection Gb, but there exists a signalling connection Gs between the support node 10, 11 and the mobile switching centre 13. In FIG. 1, the unbroken lines between the blocks illustrate data communication (i.e. transfer of speech and data in digital form), and the broken lines illustrate signalling. Physically, data can travel transparently through the mobile switching centre 13. The radio interface between the portable terminal 6 and the fixed network travels through the base station 14 and is marked with reference Um. References Abis and A illustrate the interface between the base station 14 and the base station controller 15, and in a corresponding manner, between the base station controller 15 and the mobile switching centre 13, which is a signalling connection. Reference Gn illustrates a connection between different support nodes 10, 11 of the same operator. The support nodes are normally divided into gateway support nodes (GGSN) 10 and serving support nodes (SGSN) 11, as shown in FIG. 1.

The serving GPRS support nodes 11 are connected to the mobile communication network 3 in a manner that they can provide packet switching services to terminals through base stations 14. The mobile communication network attends to packet switched communication between the support node 10, 11 and the portable terminal 6. Different subnetworks can, in turn, be connected to external data networks, such as the public packet switched data network 2, through GPRS gateway support nodes 10. Thus, the GPRS service enables packet data transmission between the portable terminal 6 and an external data network 2, wherein certain parts of the mobile communication network 3 constitute an access network. Examples of applications utilizing packet data transmission include Internet telephone communication, video conference, file transfer, and WWW (World Wide Web) and WAP (Wireless Application Protocol) browsing.

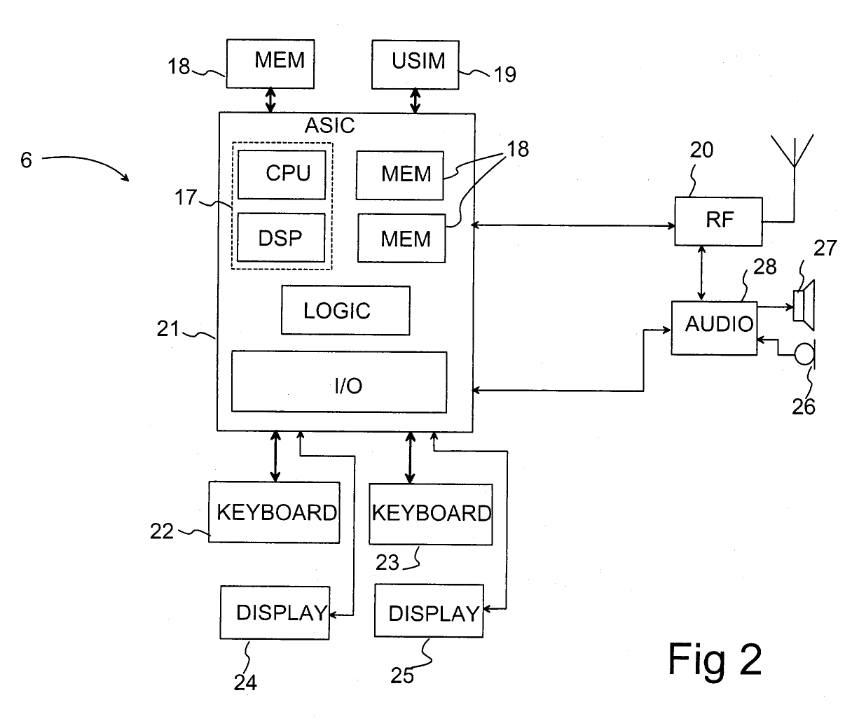

FIG. 2 shows, in a reduced block chart, a portable terminal 6 complying with a preferred embodiment of the invention, and which is here exemplified by a communication device comprising data processing functions and mobile station functions, such as Nokia 9210 Communicator. The portable terminal 6 comprises e.g. one or a plurality of processors 17 (CPU, central processing unit; DSP, digital signal processor), a memory 18, a subscriber identity module 19 (SIM; or USIM, UMTS subscriber identity module), or the corresponding means for identification of the subscriber, and a radio part 20 for communication with the base station 14. The processor 17 can be integrated e.g. in an application specific integrated circuit 21 (ASIC), which can be used to perform a large number of logical functions of the portable terminal 6. The memory 18 (storing memory) preferably comprises a random access memory (RAM), a read only memory (ROM), and at least a part of the memory of the subscriber identity module 19. The portable terminal 6 also comprises one or more user interfaces, preferably comprising a keypad 22, 23 or another means for entering data, such as a touch screen (not shown), a display 24, 25, and audio means, for example a microphone 26, a speaker 27 and a codec 28.

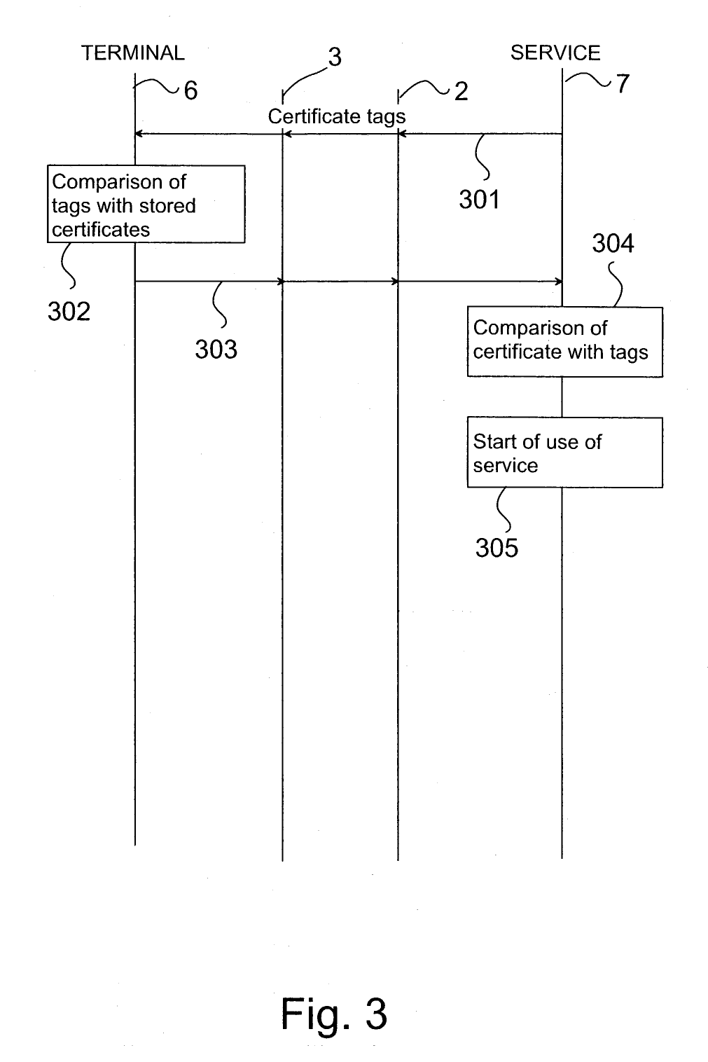

We shall next describe a situation, in which the user wants to use a service 7 by a service provider for the first time. FIG. 3 shows, in a reduced signalling chart, messages to be transmitted in the system according to an advantageous embodiment of the invention. Let us assume that the service 7 is located in a server 9 shown in FIG. 1, communicating with a packet switched data network 2, such as the Internet data network. The user uses a browser program or the like on a portable terminal 6, to enter the service in question. The user can write the address of the service or, for example, select a link which is set to point to this service. After this, information is transmitted between the wireless terminal 6 and the data network 2, to enter the desired service. In practice, entering the service means that the page settings stored in the defined address are transmitted from the service to the portable terminal 6. The information complying with these page settings is displayed on the display 24, 25 of the portable terminal 6. This is prior art known per se, wherein its description in more detail will not be necessary in this context.

The browser program can be, for example, a WAP browser, if the portable terminal 6 communicates with the data network 2 via the GSM mobile communication system. The browser can also be a www browser, for example in a situation, in which the connection from the portable terminal 6 is set up via a wireless local area network 5.

For using some services, a specific type of certificate is required. Thus, the server 9 transmits to the data network 2 a message containing information about the required certificate, i.e. the tag of the certificate. This is indicated with the reference 301 in FIG. 3. If necessary, the message is also provided with information about other conditions which are possibly set for using the service. The tag of the certificate may contain, for example, information about whether the service will accept a certificate which is electrically signed by the user. The tag of the certificate may also contain information, for example in the form of a list, about such certificate authorities whose certificates are accepted by the service, or if any certificate authority is accepted, this list is preferably blank. Furthermore, the tag of the certificate comprises an individual identification, wherein said service will preferably always use the same identification when transmitting a certificate tag message to the same user of the service. By means of this identification, the portable terminal 6 can connect certain certificate tags with the correct service. The tag of the certificate also contains information about which data of the user must be indicated in the certificate. Here, several different alternatives are possible, such as name, pseudonym or no name; address, post office box or no address; e-mail address, forwarder address or no e-mail address; age; sex; hobbies; membership or client number or another corresponding identification, such as a personal identity number; etc. The tag of the certificate also includes information about the policy of the service provider. Thus, the service will only accept, for example, certificates issued by certificate authorities with a certain policy. This policy to be defined includes, for example, information about whether the certificate authority gives information about the users who acquire certificates, further to e.g. advertisers. The policy can also include that certificates are only given to users who are older than a certain age. It is obvious that also other policies than those mentioned above can be included in the criteria of accepting certificate authorities.

The message is also provided with the address data of the recipient, wherein the message is routed to the terminal 6 in a way known as such.

In the portable terminal 6, the received message is processed and information related to the certificate is examined. On the basis of this information, certificates stored in the portable terminal 6 are compared with the certificate criteria set by the service (block 302 in FIG. 3). If a certificate fulfilling these criteria is found in the memory 18 of the portable terminal, it is selected for the use of the service. After this, the certificate is transmitted from the portable terminal 6 to the mobile communication network 3, from which it is transmitted further to the data network 2 and to the server 9 (arrow 303). In the server 9, it is still checked that the certificate meets the requirements set by the service in question (block 304). After this, the user can start to use the service, if the check-up indicates that the certificate is a certificate acceptable to the service 7 (block 305).

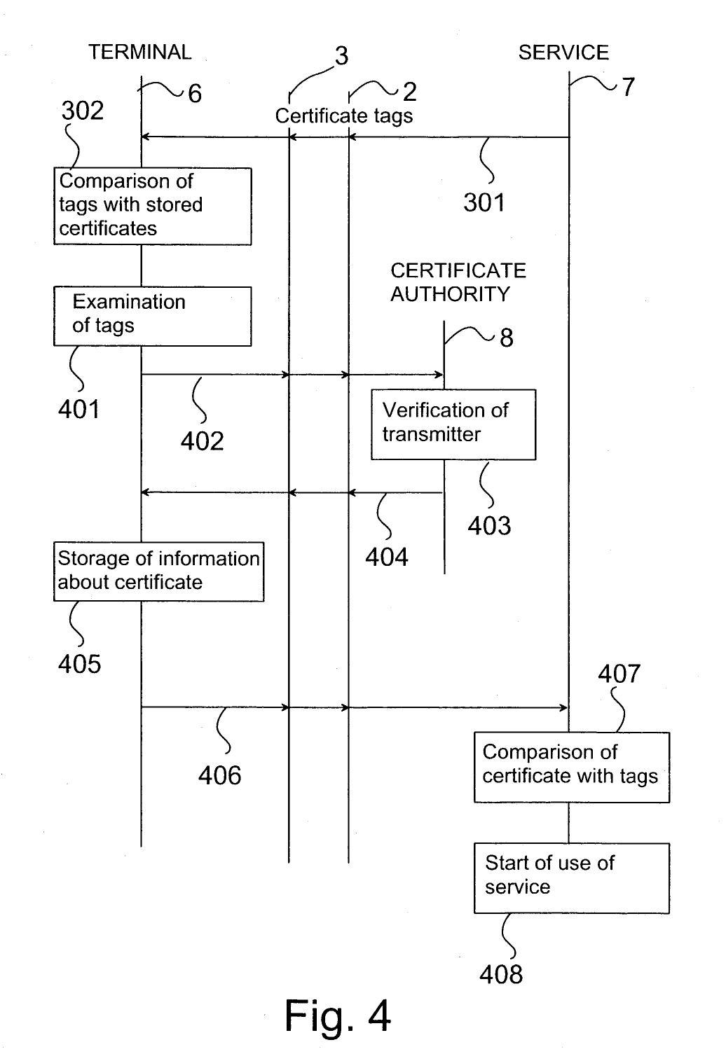

In case no certificate acceptable to the service is found in the portable terminal 6, the following steps are taken in the method according to an advantageous embodiment of the invention. FIG. 4 shows, in a reduced signalling chart, messages to be transmitted in this situation in the system according to an advantageous embodiment of the invention. In the portable terminal 6, it is examined, what kind of requirements are set for the certificate in the service (block 401). If a self-signed certificate is sufficient as the certificate, the portable terminal 6 preferably generates a new certificate and a pair of keys related to it, and the certificate is signed. Information about the certificate as well as about the individual identification transmitted by the service are stored in the memory 18, wherein the certificate is also later available for use in connection with the service in question. After this, the certificate is transmitted to the service (arrow 406), in which the certificate is examined (block 407), and the use of the service can be started (block 408).

However, if the service does not accept a self-signed certificate, the requirements set for the certificate are examined for a list of acceptable certificate authorities. If such a list is found, one of these certificate authorities is selected. If the list is blank, any certificate authority can be selected as the location for acquiring a certificate. Of the certificate tag, it is still examined, which user-specific data must be indicated in the certificate. The certificate authority has arranged a certificate server 8 or the like to communicate with the data network 2. The certificate server 8 has a certain address which can be used in communication with the certificate server, which is known as such. This certificate server 8 is provided with means (not shown), such as software and a database for generating and storing certificates. After the certificate authority has been selected, the portable terminal 6 sets up a connection with the certificate server 8 of the certificate authority and starts to acquire a certificate. The data required in the certificate are transmitted to the certificate provider (arrow 402) which makes sure, by a method known as such, that the sender of the data is really the person indicated in connection with the data (block 403). After this, a certificate is transmitted from the certificate authority to the user's portable terminal 6 for use in the service in question (arrow 404). Also in this case, information about the certificate and the individual identification of the service is stored in the memory 18 of the portable terminal (block 405). After this, the certificate is transmitted to the service (arrow 406), in which the certificate is examined (block 407), and the use of the service can be started (block 408).

In such situations, in which the certificate can be selected from several different sources, the certificate authority is preferably selected on the basis of the quantity of data on the user that must be supplied to the certificate authority. The aim is thus to select the authority in which the quantity of individual data is as small as possible, so that the identity of the user does not need to be indicated to the certificate authority.

In the above-presented steps of acquiring a certificate, the transmission of messages is preferably encrypted, wherein it is as difficult as possible to find out the data transmitted in the messages without information about the secret key necessary for decryption. This will further secure that the identity of the user remains secret.

In systems in practice, the method according to the invention can be applied in several different ways. The messages related to the certificates can be implemented in connection with different protocols to be applied in communication networks and on different protocol levels. For example, for implementing documents and pages on the application level, the hypertext markup language (HTML) is generally used in Internet data networks, or the wireless markup language (WML) derived from the HTML is used in wireless WAP applications. Thus, on the page of registration for a service, it is possible to add one or more data fields to describe the settings related to the certificate. This data field may be invisible to the user, but it is identified in the browser program of the portable terminal 6 at the stage when the browser program receives information of the service registration page, to be displayed on the display 24, 25 of the portable terminal. The browser program knows that information of a specific type must be placed in a data field of a specific type. When detecting such a data field, the browser program sets the data required by the data field in the response message to be transmitted to the service.

Another alternative to implement the invention on the application level is to add tags in the so-called META data of the registration page for using a certificate. This META data is normally placed in connection with the header of the page settings (in the Hypertext Markup Language, the tag <HEAD>is used at the beginning of the header data of a page and the tag </HEAD>at the end of the header data of a page). Thus, if the browser program detects, in connection with the registration page, a tag indicating that a certificate must be transmitted to use the service, the browser program will start to execute the functions of the method according to the invention, to select and/or acquire a certificate, if necessary.

Below the application layer, the protocol stack comprises a session layer which applies the hypertext transfer protocol (http) or, if the wireless terminal 6 is used, the wireless session protocol (wsp). The tags related to the certificates can thus be implemented on this protocol level, provided that the browser program can pick up these tags from the messages of the session layer and generate the necessary tags in the messages of this protocol layer.

The functions of the method according to the invention can also be implemented in connection with functions of said P3P system. Thus, data about the tags of the certificate required by the service is added in the P3P settings. Thus, in the browser program of the portable terminal, these tags are examined and a certificate complying with the tags is acquired, unless it is already found in the memory 18 of the portable terminal.

The present invention can also be implemented in connection with an authentication protocol which is possibly applied upon registering for a service. Thus, the authentication protocol is provided with the functions by which certificate tag data is transmitted from the service to the portable terminal 6, and the operations related to acquiring the certificate are performed.

Yet another embodiment of the invention to be mentioned is that data about the certificate types which are acceptable to the service is located in connection with an index service, such as for example a domain name service (DNS). Thus, the user can, for example by means of an inquiry to be performed by the terminal, make a search in said index service for certificates acceptable to the service, even before setting up a connection to the service in question. In the inquiry, the entered search argument is preferably the identification of the service.

We shall now describe some non-restricting example situations in which the invention can be applied. In the first example, the user wants to transmit his/her own e-mail address to a given service for later use. The user enters the registration page, or the like, of the service in question, containing a form to be filled in by the user. After the user has selected this page, the page tags and the tags related to the certificate are transmitted to the user's portable terminal 6. It is assumed that a tag of the following kind is set for the certificate in the service: “The service accepts certificates issued by certificate authorities X, Y and Z. The minimum content is an e-mail address. The acceptable policies are PA, PB and PC.” For the sake of clarity, the tags are here presented in text format, but in practical applications, the format of the tags for the certificate can be different from that presented above. After the portable terminal 6 has received this data, it examines the certificates in the memory 18 to find out if any of them complies with the set tags. Let us assume that two certificates are found which fulfill the conditions, the first being an identifying certificate which contains user identification data, and the second being a non-identifying certificate. Thus, the portable terminal 6 preferably selects the non-identifying certificate, because it is not necessary to disclose the user's identity to the service. This non-identifying certificate connects the user with his/her e-mail address. In other respects, the user's identity will not be disclosed to the service. In the portable terminal 6, the form is signed by this non-identifying certificate, and the user is asked to enter his/her password, by which the user allows the form to be transmitted back to the service. This password is used to prevent other users from impersonating said user, even though they had access to using this portable terminal 6.

In another example, the user wants to use a correspondence service (dating service). In the service, some information is collected about the users, which is used to find a person matching with the user's interests from the replies transmitted to the service. At intervals, the users must visit the service to check if a response to a contact request has been received from any person. From the point of view of the service, identity is not significant, but the service must be able to collect information, by which it is possible to find for each contact request the response of a matching person. For this reason, a tag with the following content is preferably set in the tags of the certificate: “The service will accept certificates issued by any certificate authority. The service identification is XYZOP.” In this case, the portable terminal 6 will determine that a new certificate signed by the user is to be generated for this service. Thus, a new pair of encryption keys (public key and secret key) is generated in the portable terminal 6. The certificate is signed with the secret key. In addition to the certificate, the public key is transmitted to the service, wherein the service can authenticate the certificate on the basis of this public key. After this, the user can start to use the service and enter desired information in the service. However, the user's identity, e-mail address or other information related to the person need not be transmitted at any stage to the service. When using this service later, the portable terminal 6 will detect from the service identification that a certificate has been created for the service, wherein it is retrieved from the memory 18 and transmitted to the service.

If necessary, the user can be allocated an anonymous e-mail address e.g. for using a service. Thus, the certificate to be transmitted to the service is supplied with information about said anonymous e-mail address. This makes it possible that e-mail transmitted to the user via the service can be transmitted to said anonymous e-mail address, from which the user picks up the received mail at intervals. With such an arrangement, it is possible to prevent that the user's e-mail address becomes public for other users of the service. On the other hand, the service provider may have information about the user's correct e-mail address, wherein the service provider can inform the user about received e-mail. In this alternative, the policy of the service provider should indicate whether the service provider gives information about the user's real e-mail address to third parties.

Yet a third example is a service, in which a certain age is required of the user. A tag with the following content is preferably set in the tags of the certificate: “The service accepts certificates issued by certificate authorities X, Y and Z. The minimum content is age. The acceptable policies are PA, PB and PC.” Let us assume that only an identifying certificate which does not contain information about the user's age is stored in the user's portable terminal 6. Thus, the portable terminal 6 selects, from acceptable certificate authorities, one which can issue a non-identifying certificate. After this, the portable terminal 6 sets up a connection to the selected certificate authority (for example X) and starts to take the measures required for acquiring a certificate. Next, the certificate authority generates a certificate which contains the user's age data as well as information about the policy of the certificate authority (for example PB). In this example, any other information about the user will not be needed; therefore, the certificate will not contain any other user-specific information. After the certificate has been received in the portable terminal 6, it is possible to start to use the service.

Only a few situations about the acquisition and use of certificates were exemplified above, but in practice, the method according to the invention can be applied in a variety of situations. Most of the operations of the method according to the invention can be made invisible to the user and such that the user does not need to select the certificate or to select the certificate authority from which the certificate is acquired, if necessary. The use of the certificate can thus be made as automatic as possible.

However, the user can set his/her own conditions for the policy that must be observed by the service provider, in order to acquire a certificate for the service. Thus, if the portable terminal 6 detects, when comparing the policy observed by the service provider with the requirements set by the user, that the policy does not meet these requirements, the user can be notified of this so that the user can select, whether the registration for the service is to be continued or stopped.

Most of the operations of the method according to the invention can be implemented in the application software of the portable terminal, for example in the program code of one or more processors 17, in the browser program, or the like.

Although the invention was described above by using the portable terminal 6 as an example of a terminal, it is obvious that the invention can also be applied in connection with other kinds of terminals.

It is obvious that the invention is not limited solely to the above-presented embodiments, but it can be modified within the scope of the appended claims.

1. A method for using a service at a terminal, in which method, for using the service, at least one certificate is transmitted from the terminal to said service, and requirements for the data content of the certificate are set in the service, wherein information about said requirements is transmitted from the service to the terminal, which takes a certificate acquisition step to acquire a certificate complying with the requirements, and a certificate transmission step to transmit the acquired certificate to said service.

2. The method according to claim 1, wherein in the certificate acquisition step, it is examined, if a certificate complying with the requirements is stored in the terminal, and if a certificate complying with the requirements is found on the basis of the examination, it is selected to be transmitted to said service.

3. The method according to claim 2, wherein if a certificate complying with the requirements is not found in the terminal, it is examined from the requirements set for the certificate, if a certificate generated in the terminal will be acceptable to the service, wherein if a certificate generated in the terminal will be acceptable to the service, the terminal takes a certificate generation step to generate a certificate, to examine from the certificate requirements, what information should be included in the certificate, and to provide the certificate with information complying with the requirements for the certificate.

4. The method according to claim 2, wherein if a certificate complying with the requirements is not found in the terminal, it is examined from the requirements set for the certificate, which certificate authority is acceptable to the service to issue a certificate, wherein the terminal selects one of the certificate authorities included in the certificate requirements, and the certificate is acquired from said selected certificate authority.

5. The method according to claim 1, wherein the acquired certificate is stored in the terminal.

6. The method according to claim 1, wherein the service is allocated an index which is connected to the certificate acquired in the terminal, wherein the acquired certificate is used in the terminal later on when using the same service.

7. The method according to claim 1, wherein if the number of available certificates is more than one, a certificate containing as little information related to the user's person as possible is selected to be transmitted to the service.

8. The method according to claim 1, wherein the certificate is a non-identifying certificate, wherein information, on the basis of which the user can be identified, is excluded from the certificate.

9. The method according to claim 1, wherein the information to be included in the certificate contains at least one of the following items of user-specific information:
pseudonym,
e-mail address,
name,
age,
sex,
hobbies,
membership number,
client number,
identity code.

10. The method according to claim 1, wherein an anonymous e-mail address is formed for the user to use the service, wherein the certificate to be transmitted to the service is provided with information about said anonymous e-mail address, and any e-mail to be transmitted to the user via the service is transmitted to said anonymous e-mail address.

11. The method according to claim 4, wherein the server transmits information about the certificate authorities whose certificates are acceptable to the service.

12. The method according to claim 1, wherein the server transmits to the terminal at least one message which contains information about said requirements for the data content of the certificate needed in the service.

13. The method according to claim 11, wherein the server transmits to the terminal at least one message which contains information about said requirements for the data content of the certificate needed in the service, and said message contains a list of the certificate authorities whose certificates are accepted in the service.

14. A system which comprises services, means for using at least one service at a terminal, means for transmitting at least one certificate from the terminal to said service for using the service, and in which service requirements are set for the data content of the certificate, wherein the system also comprises means for transmitting information about said requirements from the service to the terminal, which terminal comprises means for acquiring a certificate complying with the requirements, and means for transmitting the acquired certificate to said service.

15. The system according to claim 14, wherein the means for acquiring the certificate comprise means for examining, if a certificate complying with the requirements is stored in the terminal, and means for selecting a certificate complying with the requirements to be transmitted to said service, if a certificate complying with the requirements has been found on the basis of the examination.

16. The system according to claim 14, wherein the requirements contain information about whether a certificate formed in the terminal is accepted in the service, wherein the system comprises means for examining said information, and means for forming a certificate in the terminal.

17. The system according to claim 14, wherein the requirements contain information about what data must be included in the certificate, wherein the system comprises means for providing the certificate with data complying with the requirements of the certificate.

18. The system according to claim 14, wherein the requirements contain information about the certificate authority whose certificate is acceptable to the service, wherein the system comprises means for selecting one of the certificate authorities indicated in the requirements of the certificate, and means for acquiring a certificate from said selected certificate authority.

19. The system according to claim 14, wherein the service is allocated an index which is connected to the certificate acquired in the terminal, wherein the system comprises means for using the acquired certificate in the terminal when using the same service later on.

20. The system according to claim 14, wherein the certificate is a non-identifying certificate, wherein information, on the basis of which the user can be identified, is excluded from the certificate.

21. The system according to claim 14, wherein the data included in the certificate contains at least one of the following items of user-specific information:
pseudonym,
e-mail address,
name,
age,
sex,
hobbies,
membership number,
client number,
identity code.

22. The system according to claim 14, wherein an anonymous e-mail address is generated for the user to use the service, wherein the certificate to be transmitted to the service is provided with data about said anonymous e-mail address, and the system also comprises means for transmitting any e-mail to be transmitted to the user via the service to said anonymous e-mail address.

23. A terminal for use in a system comprising services, which terminal comprises means for using at least one service, means for transmitting at least one certificate from the terminal to said service for using the service, and in which service requirements are set for the data content of the certificate, wherein the terminal also comprises means for receiving information about said requirements transmitted from the service, means for acquiring a certificate complying with the requirements, and means for transmitting the acquired certificate to said service.

24. The terminal according to claim 23, wherein the means for acquiring the certificate comprise means for examining, if a certificate complying with the requirements is stored in the terminal, and means for selecting a certificate complying with the requirements to be transmitted to said service, if a certificate complying with the requirements has been found on the basis of the examination.

25. The terminal according claim 23, wherein it comprises means for storing the acquired certificate.

26. The terminal according to claim 23, wherein it comprises means for examining the amount of data related to the user's person in the selectable certificates, and means for selecting the certificate to be transmitted to the service on the basis of the amount of data related to the user's person in the certificate.

27. A mobile station for use in a system comprising services, which mobile station comprises means for using at least one service, means for transmitting at least one certificate from the terminal to said service for using the service, and in which service requirements are set for the data content of the certificate, wherein the mobile station also comprises means for receiving information about said requirements transmitted from the service, means for acquiring a certificate complying with the requirements, and means for transmitting the acquired certificate to said service.
